(19) United States
(12) Patent Application Publication
(10) Pub. No.: US 2015/0193826 A1
(43) Pub. Date: Jul. 9, 2015

(54) METHOD AND SYSTEM FOR TARGETING ADVERTISEMENTS TO MULTIPLE USERS

(71) Applicant: QUALCOMM Incorporated, San Diego, CA (US)

(72) Inventor: Michael-David Nakayoshi Canoy, San Diego, CA (US)

(73) Assignee: QUALCOMM Incorporated, San Diego, CA (US)

(21) Appl. No.: 14/147,845

(22) Filed: Jan. 6, 2014

(51) Int. Cl. G06Q 30/02

(52) U.S. Cl. CPC G06Q 30/0269

(57) ABSTRACT

A method for targeting an advertisement includes receiving contextual data related to a plurality of users, aggregating the contextual data related to the plurality of users, sensing when the plurality of users approaches an advertising medium, tailoring one or more advertisements to the plurality of users based on the contextual data, and providing the one or more targeted advertisements to the plurality of users through the advertising medium.

### DESCRIPTION OF THE RELATED ART

A targeted advertising system can be configured to direct advertisements to individuals based on a number of factors including, gender, appearance, etc. For example, a facial recognition system may be employed by an advertising system to determine the gender of an individual entering an environment, and then use the gender information to direct an advertisement to that individual based on their gender.

However, such systems do not consider the habits and profiles of an individual, and are not adaptable to consider multiple users, multiple advertisements, and multiple advertising mediums.

### BRIEF DESCRIPTION OF THE DRAWINGS

In the figures, like reference numerals refer to like parts throughout the various views unless otherwise indicated. For reference numerals with letter character designations such as “102a” or “102b”, the letter character designations may differentiate two like parts or elements present in the same figure. Letter character designations for reference numerals may be omitted when it is intended that a reference numeral encompass all parts having the same reference numeral in all figures.

FIG. 1 is a functional block diagram illustrating an embodiment of a system for targeting advertisements to multiple users.

FIG. 2 is a diagram illustrating an example of a PPC table of FIG. 1.

FIG. 3 is a block diagram of an embodiment of the advertising manager of FIG. 1.

FIG. 4 is a flow chart describing the operation of an embodiment of a method for targeting advertisements to multiple users.

FIG. 5 is a flow chart describing the operation of an embodiment of a method for selecting an advertisement with the highest correlation to user PPC information.

FIG. 6 is a block diagram illustrating an example of a wireless device in which aspects of the system and method for targeting advertisements to multiple users can be implemented.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

As used herein, the terms “user device” and “client device” include a device capable of receiving content from a web site or server and transmitting information to a website or server. A user device or client device can be a stationary device or a mobile device. The terms “user device” and “client device” can be used interchangeably.

As used herein, the term “user” refers to an individual receiving content on a user device or on a client device and transmitting information to a website or server.

As used herein, the term “context” refers to any or all attributes of the user or the user device, such as physical, logical, social, historical and other contextual information.

As used herein, the terms “context aware metadata” and “contextual metadata” refer to metadata that describes or defines the context of a user or a user device.

As used herein, the term “context aware content” refers to content that is delivered to a user device and that is tailored to a user's context.

As used herein, the term “contextual data” refers to one or more of user profile information, user preference information and user context information.

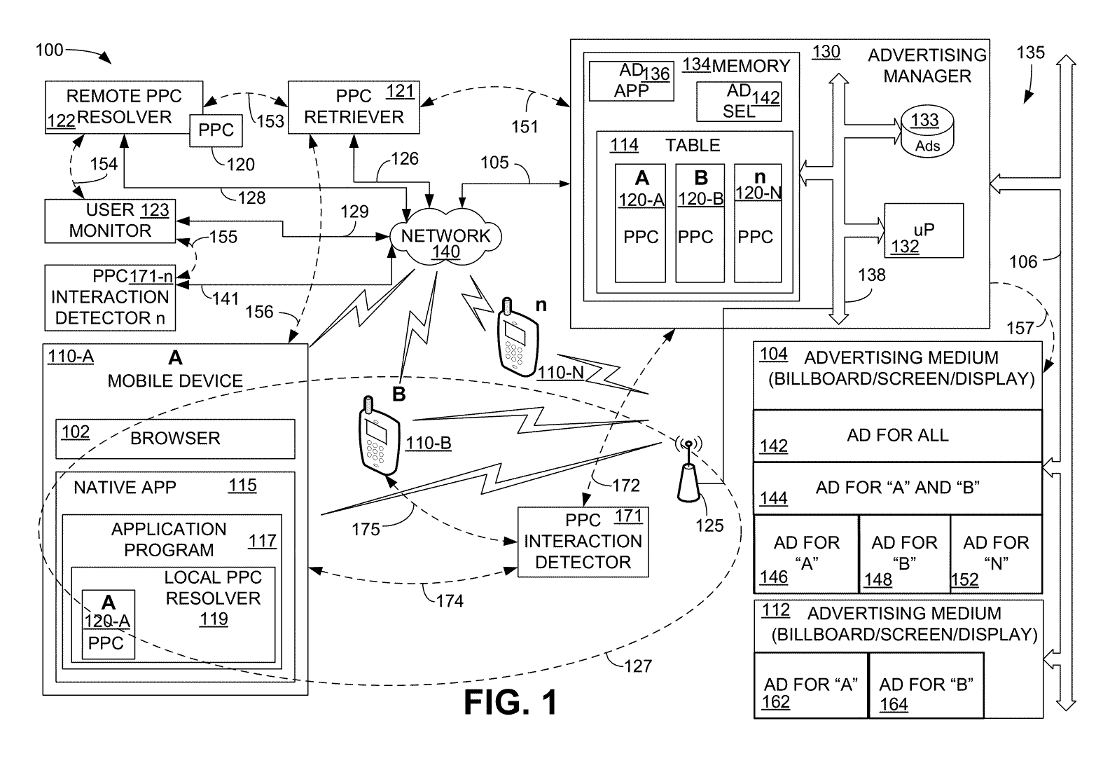

FIG. 1 is a functional block diagram illustrating an embodiment of a system for targeting advertisements to multiple users. The system 100 comprises mobile devices 110-A through 110-N that are operatively connected to an advertising manager 130 and operatively connected to a network 140. Reference to a mobile device 110 is applicable to each mobile device 110-A through 110-N. The advertising manager 130 can be connected to the network 140 over a connection 105, which can be a wired or a wireless connection. The advertising manager 130 can be part of, or can be operatively connected to, one or more advertising mediums. In an embodiment, a first advertising medium may comprise a billboard or display 104 and a second advertising medium may comprise a billboard or display 112. The advertising manager 130 can be operatively coupled to the advertising medium 104 and advertising medium 112 over a communication bus 106, or another network or connection. The communication bus 106 contains the physical and logical connections that allow the connected devices to communicate and interoperate. In an embodiment, the advertising manager 130, the advertising medium 104, and/or the advertising medium 112 may be a single component located at a single location, and referred to as an advertising system 135. Although one advertising system 135 is shown in FIG. 1, it is contemplated that multiple advertising systems 135 could be part of the system 100. Alternatively, the advertising manager 130, the advertising medium 104, and/or the advertising medium 112 may be separate elements that can be operatively connected over one or more communication networks. In an illustrative embodiment, the advertising manager 130 can include one or more advertising mediums and can be a self-contained billboard along a highway, or can be a display screen or series of display screens in an urban, or other, environment.

In an alternative embodiment, the advertising manager 130 can be located remotely from the advertising medium 104 and/or 112 and coupled thereto over one or more communication networks. The network 140 can be a wide area network (WAN), a local area network (LAN), a public network, a private network, a cellular communication network, or any other communication network, and in an embodiment, can comprise at least portions of the Internet.

In an embodiment, the advertising manager 130 may comprise a processor 132, a memory 134 and a database 133, operatively coupled together over a communication bus 138. The communication bus 138 contains the physical and logical connections that allow the connected devices to communicate and interoperate. The memory 134 may include an advertising (ad) application program 136 containing instructions for operating the advertising manager 130 in general, and for operating aspects of the method and system for targeting advertisements to multiple users, and an ad selection program 142 for selecting an advertisement from the database 133, both of which contain sets instructions that can be executed by the processor 132. The database 133 may contain content, such as advertising content, that can be stored, selected, and processed by the processor 132. A wireless access point 125 may also be operatively connected to the communication bus 138. The wireless access point 125 is an example of one or more wireless access points that embody a wireless communication infrastructure such as, for example, a short to medium range wireless communication system such as a wireless fidelity (WiFi), Bluetooth, cellular, or another communication network. The wireless access point 125 can establish a detector proximity field 127, which, in this example, encompasses mobile devices 110-A and 110-B. However, mobile devices 110 can enter and exit the detector proximity field 127 repeatedly.

In this example, three mobile devices, 110-A, 110-B and 110-N are illustrated; however, a typical implementation would include many more mobile devices. The mobile device 110 can be any mobile computing device, such as a cellular telephone, a tablet computing device, a personal digital assistant, a netbook or notebook computing device, or any other mobile communication device. The mobile devices 110 may be connected to the network 140 via a cellular-type of communication network, and to the access point 125 via a number of different wireless methodologies, such as, for example only, a cellular communication system, a short range-wireless communication system such as WiFi or Bluetooth, a combination of two or more wireless communication systems, or any other communication network infrastructure.

With particular reference to mobile device 110-A, but equally applicable to all mobile devices 110, the mobile device 110-A comprises a browser 102, a native application 115 and an application program 117. In this example, the application program 117 can be part of the native application 115, and can be a context awareness application, or any application that can gather and maintain profile, preferences and contextual (herein abbreviated as “PPC”) information relating to the mobile device 110 and a user of the mobile device 110. The native application 115 can be any application that is resident on, or accessible by the mobile device 110. The terms “PPC,” “PPC information” and “PPC data” refer to any information relating to the user preferences, user profile, user browsing habits, user location, places the user visits, work location, home location, other locations that are relevant to the user of the mobile device 110, or any other contextual information related to the user of the mobile device 110.

In an embodiment, the application program 117 can be what is referred to as a “listener” application that obtains the above-mentioned contextual information relating to the mobile device 110 in cooperation with or independent from the operation of the browser 102. The application program 117 includes an instance of a local PPC resolver 119. The local PPC resolver 119 builds and maintains a table 120-A. In an embodiment, the table 120-A can be referred to as a “PPC table” that includes profile, preferences and contextual information, referred to as “PPC information” or “PPC data” that is relevant to the user of the mobile device 110-A. Each mobile device 110 includes such a PPC table 120 having PPC data associated with the user of each mobile device 110 and with each mobile device 110. The local PPC resolver 119 also includes aspects of a database for maintaining data for responding to a query, and can actively transmit, transfer, or otherwise make available the PPC data in the PPC table 120-A to the advertising manager 130. Although shown as being within a native application 115, the application program 117 may be a separate application. Omitted for simplicity are the radio frequency (RF), baseband processing, memory, and other related elements that are part of the communication device 110-A as known to those having ordinary skill in the art.

The system 100 also comprises a PPC retriever 121, a remote PPC resolver 122, a user monitor 123, a PPC interaction detector 171 and a PPC interaction detector 171-n. The PPC retriever 121, remote PPC resolver 122, user monitor 123, and PPC interaction detector 171-n are connected to the network 140 over respective connections 126, 128, 129 and 141, which enables their interoperability. The connections 126, 128, 129 and 141 can be any communication channels or connections that allow the connected devices and elements to interoperate. The PPC retriever 121, remote PPC resolver 122, user monitor 123, PPC interaction detector 171, and PPC interaction detector 171-n can be software modules or combinations of hardware and software elements that can reside on one or more computing platforms, such as one or more server computing devices. In an embodiment, an instance of the PPC retriever 121, user monitor 123, and PPC interaction detector 171 may reside in or in communication with the advertising manager 130. An instance of the remote PPC resolver 122 may reside separate from the advertising manager 130, but in operative communication with the advertising manager 130, the PPC retriever 121 and the user monitor 123. For example, an instance of the remote PPC resolver 122 may reside on a server device that can be accessed by the advertising manager 130, and a number of other advertising managers, or other advertising systems. Further, the remote PPC resolver 122 may be deployed in a hierarchical manner in which one remote PPC resolver 122 may support multiple geographical regions.

The PPC retriever 121 obtains PPC data from the local PPC resolver 119 (shown using logical connection 156) located on a mobile device 110, or from the remote PPC resolver 122 (shown using logical connection 153). The PPC retriever 121 makes the PPC data available to the advertising manger 130 over logical connection 151. If the PPC data is not available, then the PPC retriever 121 can, for example, assume PPC data using generic assumptions associated with a particular geographic region or it can assume random or biased PPC data relevant to a particular advertisement. An example for a situation in which PPC data is not available is the system 100 providing an advertisement for a product or service that the product or service provider wishes to advertise, regardless of any specific information relating to the individual that may be viewing the advertisement. Alternatively, if no PPC data is available, the system 100 may not display any advertisement.

The remote PPC resolver 122 maintains user PPC data and can collect that PPC data over time, such as over several interactions with the advertising manager 130 or other advertising systems 135. The remote PPC resolver 122 also has a logical connection 154 with the user monitor 123, which allows the remote PPC resolver 122 to receive PPC data from the user monitor 123.

The local PPC resolver 119 resides on the mobile device 110 and has access to PPC data in the PPC table 120-A. For example, the user of the mobile device 110-A could provide PPC data directly, via for example, an application setting, or the mobile device 110-A may obtain PPC data indirectly via, for example, the application program 117.

An example of a way in which the PPC retriever 121 can obtain the PPC data includes directly communicating with the mobile device 110-A via, for example, a radio frequency (RF) communication link once the mobile device 110-A is detected within proximity of the advertising medium 104 or 112. In another example, the mobile device 110-A may broadcast PPC data in the detector proximity field 127 and when the user is within range the remote PPC resolver 122 could cache the PPC data and keep it ready for when the PPC retriever 121 requests it.

The user monitor 123 allows mobile devices 110 to be tracked across multiple advertising systems 135, or across multiple advertising mediums within the same advertising system 135. For example, if the mobile device 110-A was interacting with advertising medium 104 and the advertising medium 112 was five (5) minutes away at the current or likely speed, the advertising manager 130 associated with the advertising medium 112 could start to cache ads targeted for the user and prepare for the users arrival. Additionally if the advertising manager 130 desired other PPC data from a remote resource, it could fetch it ahead of time. Further, the advertising manager 130 could bias the selected advertisement towards an advertisement that has been seen by the user multiple times over a trip.

Although being illustrated as being within the detector proximity field 127, the PPC interaction detector 171 can be located in or can be operatively connected to the advertising manager 130. In this example, the PPC interaction detector 171 is shown as being within the detector proximity field 127 to illustrate that it detects the presence of the user devices 110-A and 110-B and can be remote from the advertising manager 130. The interaction detector 171 selects the mobile devices 110 that are within proximity of the advertising manager 130, for example, those mobile devices that are within the detector proximity field 127. The interaction detector 171 detects the mobile device 110-A, shown using logical connection 174, and can store a history of the mobile devices' presence in the area as well as providing relevant information (speed, direction, car color . . . ) to the user monitor 123 to enhance user tracking. As an example, the interaction detector 171 may include one or more radio frequency (RF) modules to allow it to interact and detect the mobile device 110-A and to communicate with the access point 125. The interaction detector 171 communicates to the advertising manager 130 via connection 172, which can be an RF connection, a notification which then triggers the PPC retriever 121 and the user monitor 123 to track the mobile device 110-A across multiple advertising mediums, or across multiple advertising systems. The interaction detector 171 also interacts with the mobile device 110-A via an RF connection 174 to detect the proximity of the mobile device 110-A relative to the advertising medium 104 and the advertising medium 112, as mentioned above; and also can interact with the mobile device 110-B via an RF connection 175 to detect the proximity of the mobile device 110-B relative to the advertising medium 104 and the advertising medium 112.

A PPC table 120 from a mobile device 110 can be provided to the advertising manager 130 via the network 140 (through the PPC retriever 121), via the access point 125, or via other communication channels.

The advertising manager 130 also comprises a master table 114 that comprises instances of a PPC table 120 related to each mobile device 110. In this manner, the advertising manager 130 can aggregate PPC information related to each mobile device 110, and can target advertisements via the advertising medium 104 and/or the advertising medium 112 to one or more users of mobile devices 110 based on the PPC table 120 relevant to the user of each mobile device 110.

The advertising manager 130 can be any computing device configured as a server and includes processing, memory, storage, database, input, output, communication, and other elements. In an embodiment, the advertising manager 130 is configured to operate in conjunction with the application program 117 and the local PPC resolver 119 located on the mobile device 110. A mobile device 110 periodically transmits, uploads, or otherwise transfers, either proactively, or in response to a request from the advertising manager 130, the contents of the PPC table 120 that includes the contextual and behavioral information related to a mobile device 110 and the habits and behaviors of a user of a mobile device 110. The advertising manager 130 stores each PPC table 120 in the master table 114, with the PPC tables 102-A, 120-B and 120-N referring to the PPC table associated with the mobile devices 110-A, 110-B and 110-N, respectively. In this manner, each of the mobile devices 110 communicates a PPC table 120 to the advertising system 130, and the advertising system 130 maintains a copy of each PPC table 120 and periodically, in real-time, or in near-real time, updates each PPC table 120 based on the real-time, or near-real time information provided by each mobile device 110.

In a particular use example, the mobile device 110-A and 110-B are traveling in an automobile and pass within, or enter within, communication range of the detector proximity field 127 established by the access point 125. The PPC interaction detector 171 detects the presence of mobile device 110-A, depicted over logical connection 174, and detects the presence of mobile device 110-B, depicted over logical connection 175. The mobile device 110-N may be located outside of the detector proximity field 127 and therefore is not detected by the PPC interaction detector 171, but, in an embodiment, may be considered to be in the area by the advertising manager 130. As mentioned above, the user monitor 123 tracks a mobile device 110 user across multiple advertising systems and can determine that the mobile device 110-N is in the geographic area of the advertising manager 130, even if the mobile device 110-N is not within the detector proximity field 127. Additionally, the user monitor 123 could use other tools, such as GPS data, environmental factors such as weather, as in local weather or types of weather one encounters on the users path through the advertising system 135 to further develop context for the PPC data.

The PPC interaction detector 171 notifies the advertising manager 130 of the presence of the mobile devices 110-A and 110-B, depicted over logical connection 172. The PPC interaction detector 171 detects when PPC data can be leveraged in a particular location using user proximity and the approximate distance and likelihood of interactivity (e.g., visual, audio, etc.) with the advertising medium 104 and/or 112.

The advertising manager 130 collects and logs PPC trigger events from the PPC interaction detector 171 and queries the PPC retriever 121 for PPC data, depicted over logical connection 151. In this example, the advertising manager 130 may query the PPC retriever 121 for PPC data 120 relating to the used device 110-A and 110-B.

The PPC retriever 121 queries and receives PPC data 120 from the local PPC resolver 119 in the mobile device 110-A (and similarly with the mobile device 110-B, although those details are omitted), depicted over logical connection 156; and also queries and receives PPC data 120 from the remote PPC resolver 122, depicted over logical connection 153. The remote PPC resolver 122 may be a device located remotely from each mobile device 110. For example, the remote PPC resolver 122 may be a global PPC storage element for all users of the system 100. A remote PPC resolver 122 may be available to more than one advertising manager 130.

The user monitor 123 can track the movements of the mobile devices 110, can have information as to which advertisements have been displayed to a particular user at a particular time and may provide trend information that may be used to derive context of a user of a mobile device 110, depicted over logical connection 154. The user monitor 123 may also determine other user interaction by accessing the PPC interaction detector 171-n, depicted over logical connection 155.

A global timing function may be provided by the user monitor 123, by the advertising manager 130 and/or by any of the local PPC resolver 119 or the remote PPC resolver 122.

The advertising manager 130 receives the relevant PPC information relating to the mobile devices 110-A, 110-B and 110-N, from the PPC retriever 121. The advertising manager 130 then aggregates and processes the PPC tables 120-A, 120-B and 120-N to select one more advertisements from the database 133 for presentation to the users of the mobile devices 110-A, 110-B and 110-N based on the contextual information contained in the respective PPC tables 120-A, 120-B and 120-N. Advertisements are provided from the advertising manager 130 to the advertising medium 104 and to the advertising medium 112 over logical connection 157.

In an embodiment, the advertising medium 104 can comprise one or more displays, screens, portions of screens, etc. In an embodiment, the advertising medium 104 can be a display screen having display portions 142, 144, 146, 148 and 152. The display portions 142, 144, 146, 148 and 152 are shown for illustrative purposes only. The advertising medium 104 can contain more or fewer display portions, and can comprise display portions having relative sizes different than that shown, can comprise multiple displays, and can comprise other mediums.

In an embodiment, the display portion 142 can be configured to display an advertisement that is not targeted, but instead, is intended for all passersby. However, the display portion 144 can be controlled by the advertising manager 130 to display, in this example, an advertisement that is targeted to the user of the mobile device 110-A and the user of the mobile device 110-B based on their respective PPC tables 120-A and 120-B. Further, the display portion 146 can display an advertisement individually targeted for the user of the mobile device 110-A based on the PPC table 120-A, the display portion 148 can display an advertisement individually targeted for the user of the mobile device 110-B based on PPC table 120-B, and the display portion 152 can display an advertisement individually targeted for the user of the mobile device 110-N based on PPC table 120-N. Similarly, advertising medium 112 may comprise display portion 162 and display portion 164, where the display portion 162 can display an advertisement targeted for the user of the mobile device 110-A based on the PPC table 120-A, and the display portion 164 can display an advertisement targeted for the user of the mobile device 110-B based on the PPC table 120-B. Alternatively, the advertising medium 104 can display an advertisement individually targeted for the user of the mobile device 110-A and the advertising medium 112 can display an advertisement individually targeted for the user of the mobile device 110-B. The advertising system 130 allows the aggregation and processing of any quantity of PPC information so that advertisements can be individually targeted in any combination to target any combination of mobile devices 110.

The method and system for targeting advertisements to multiple users is not limited to billboard, or visible display advertisements. In alternative embodiments, the method and system for targeting advertisements to multiple users can be used to target advertisements using other communication or advertising mediums, such as altering an audio stream of a radio broadcast, altering an audio and video stream of a television broadcast, or altering other mediums.

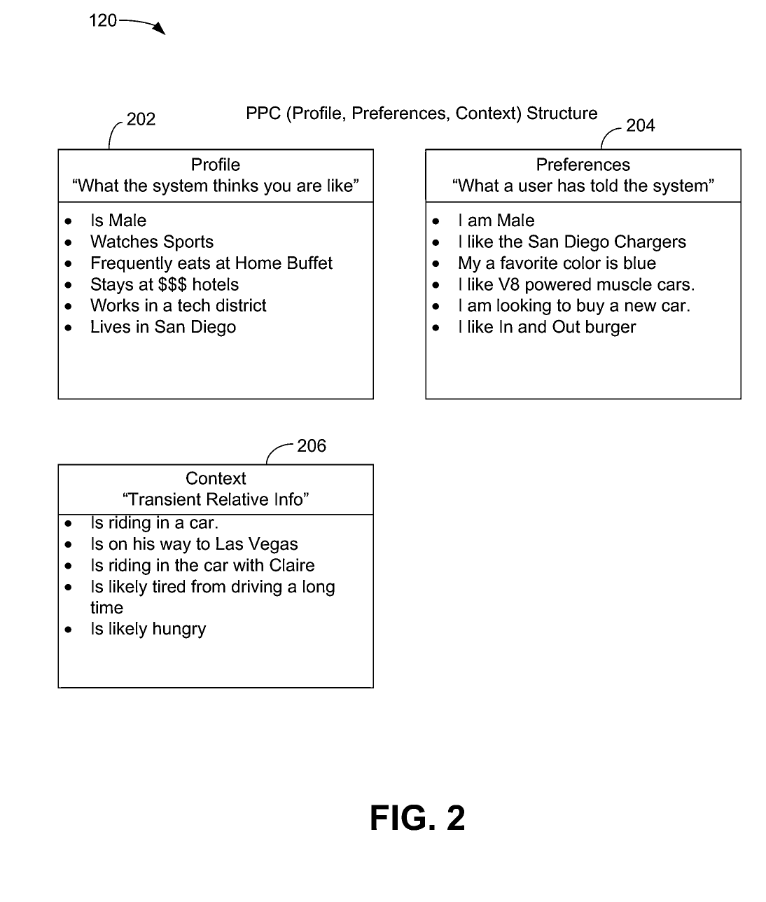

FIG. 2 is a diagram illustrating an example of a PPC table 120. The example shown in FIG. 2 is general in nature and is intended to be only an example of the type of PPC information that may be contained in a PPC table 120. The example PPC table 120 comprises a “Profile” section 202, a “Preferences” section 204 and a “Context” section 206. In an embodiment, the “Profile” section 202 may comprise information relating to the user of the mobile device 110. Examples of “Profile” information include, but are not limited to, gender, interests, work location, residence location, etc. The “Profile” information is generally created by monitoring the habits of the user of the mobile device.

In an embodiment, the “Preferences” section 204 may comprise information relating to what the user has communicated to the advertising manager 130. Examples of “Preferences” information include, but are not limited to, gender, interests, likes/dislikes, work location, residence location, etc. The “Preferences” information is generally created by the user of the mobile device.

In an embodiment, the “Context” section 206 may comprise information relating to transient relative information relevant to the user of the mobile device 110 at a particular time. Examples of “Context” information include, but are not limited to, where the user is located at a particular time, where the user may be going, whether the user is walking or riding in a car, etc. The “Context” information is generally created by monitoring the habits of the user of the mobile device 110.

The PPC table 120 can be in the form of a table or a general database that is understood by the advertising manager 130. The format of the PPC table 120 is relevant only to the extent that it should be readable and transportable by the elements of the system 100. For example, the PPC table 120 can be transportable and readable using JavaScript Object Notation (JSON).

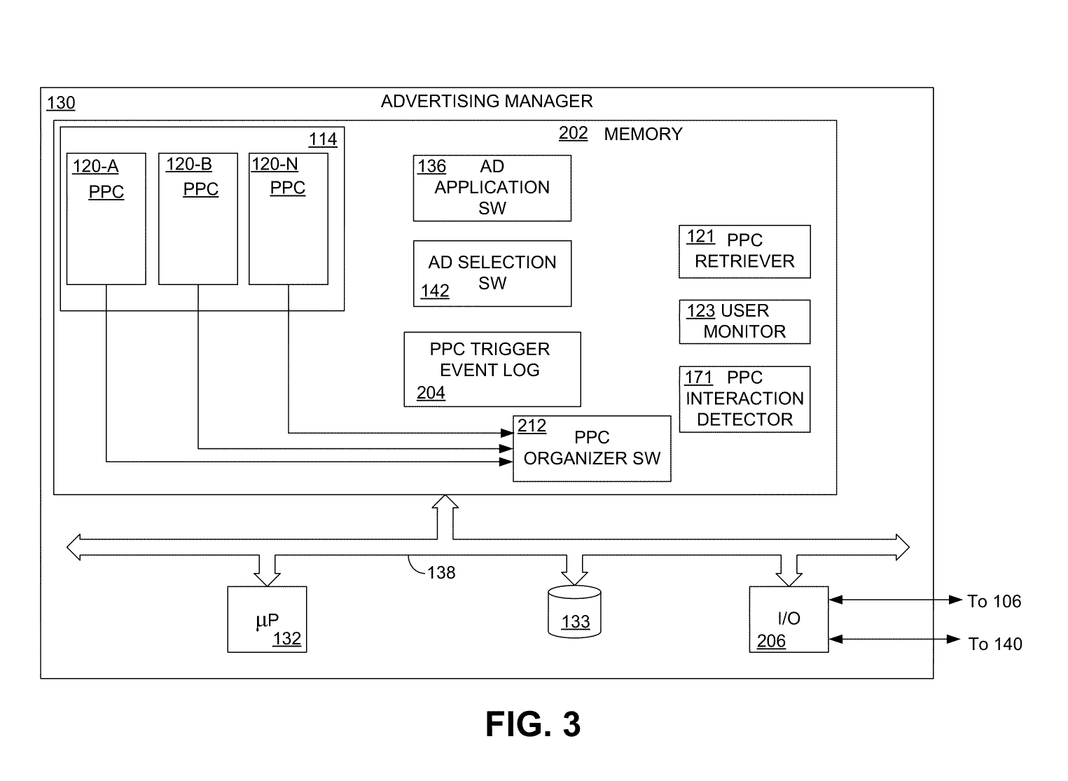

FIG. 3 is a block diagram of an embodiment of the advertising manager 130 of FIG. 1. In an embodiment, the advertising manager 130 comprises a memory 202, a processor 132, a database 133 and an input/output (I/O) element 206, operatively connected over a system bus 138. The memory 202 can comprise any type of volatile or non-volatile memory, shared memory, distributed memory, and in an embodiment, can be non-volatile memory that stores a PPC trigger event log 204, a PPC organizer software module 212, an advertising (ad) application software module 136, and an ad selection software module 142.

The processor 132 can be a general purpose or special purpose microprocessor that executes the ad application software module 136, the ad selection software module 142, the PPC retriever 121, the user monitor 123, the PPC interaction detector 171 and the PPC organizer software module 212; and that can process the PPC trigger event log 204. The system bus 138 can comprise the physical and logical connections to couple the above-described elements together and enable their interoperability.

In an embodiment, the memory 202 comprises a master table 114 having individual tables 120-A through 120-N corresponding to each mobile device 110-A through 110-N (FIG. 1). Each table 120-A through 120-N can comprise a PPC table containing the “Profile” “Preferences” and “Context” of its respective mobile device 110. Although shown in table form in the memory 202, each table 120-A through 120-N may be stored in the memory 202 as a file, general data, or other formats, and can be structured, indexed, or otherwise contained in a database format that allows searching, updating and providing an output to the PPC organizer software module 212. The PPC organizer software module 212 aggregates the PPC data for each table 120 and makes the PPC data available to the ad application software module 136 and the ad selection software module 142 to allow the advertising manager 130 to tailor an advertisement to one or more users via one or more advertising mediums.

In an embodiment, the advertising manager 130 may comprise instances of the PPC retriever 121, remote PPC resolver 122, user monitor 123 and the PPC interaction detector 171, which can be software modules or code segments for performing the described functions.

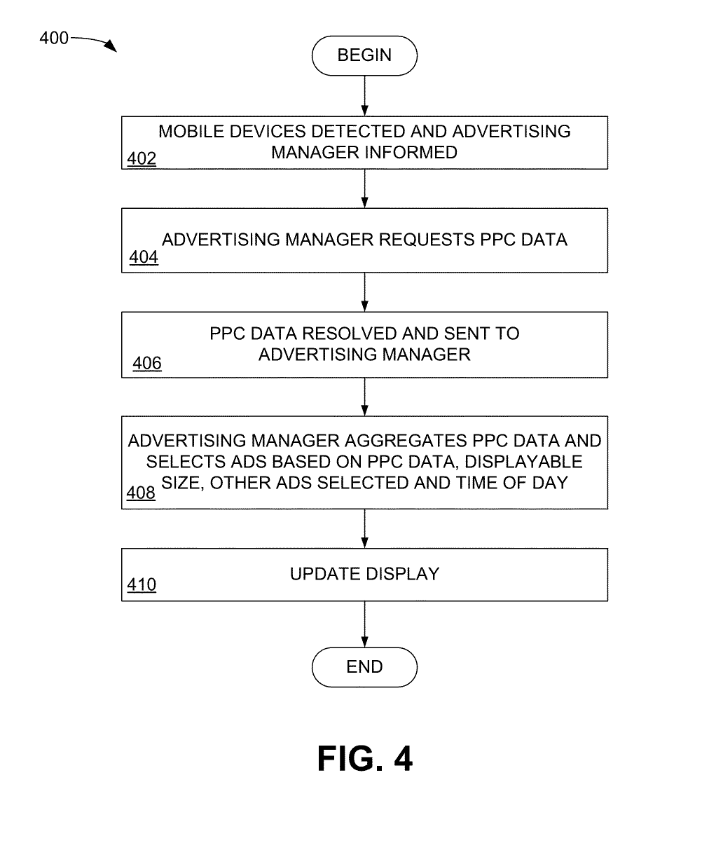

FIG. 4 is a flow chart 400 describing the operation of an embodiment of a method for targeting advertisements to multiple users. In block 402, mobile devices are detected and the advertising manager 130 is informed of the presence of the mobile devices. In an embodiment, the PPC interaction detector 171 notifies the advertising manager 130 of the presence of the mobile devices 110-A and 110-B.

In block 404, the advertising manager 130 requests the PPC(s) for the detected mobile devices. In an embodiment, the advertising manager 130 collects and logs PPC trigger events from the PPC interaction detector 171 and queries the PPC retriever 121 for PPC data relevant to the detected mobile devices.

In block 406, the PPC(s) are resolved and sent to the advertising manager 130. In an embodiment, the PPC retriever 121 queries and receives PPC data 120 from the local PPC resolver 119 in the mobile device 110-A (and similarly with the mobile device 110-B, although details are omitted); and also queries and receives PPC data 120 from the remote PPC resolver 122.

In block 408, the advertising manager 130 receives the relevant PPC information relating to the mobile devices 110-A, 110-B and 110-N, from the PPC retriever 121, or from the access point 125. The advertising manager 130 then aggregates and processes the PPC tables 120-A, 120-B and 120-N to select one more advertisements from the database 133 for presentation to the users of the mobile devices 110-A, 110-B and 110-N based on the contextual information contained in the respective PPC tables 120-A, 120-B and 120-N, display size available, time of day, and other factors.

In block 410, the advertising medium 104 is updated with the selected advertisements.

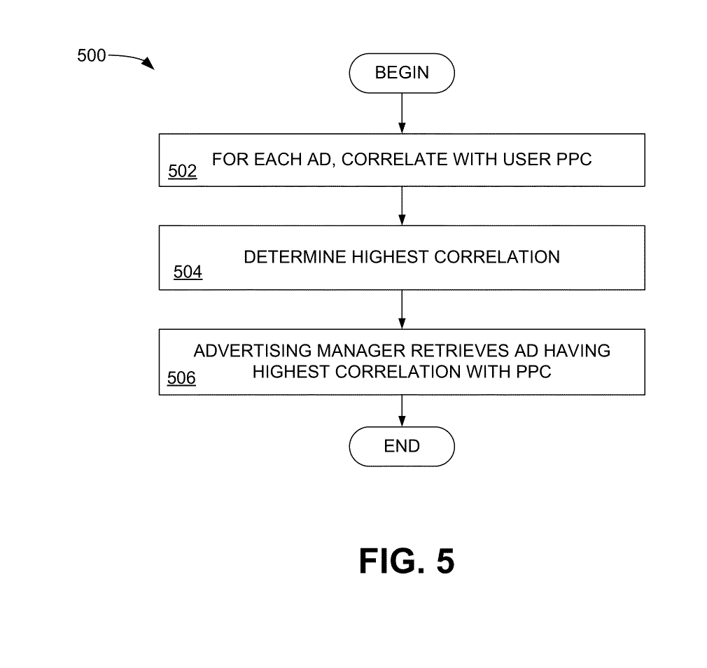

FIG. 5 is a flow chart 500 describing the operation of an embodiment of a method for selecting an advertisement with the highest correlation to user PPC information.

In block 502, each advertisement is correlated with a PPC table.

In block 504, the highest correlation is determined. The PPC data can be assigned a weighted value, such as sports being weighted an arbitrary value of 10 pts, being male being weighted an arbitrary value of 10 pts, being at least 21 years of age being weighted an arbitrary value of 10 pts, etc. Similarly, advertisements could also be weighted. For example, a pet food ad could be weighted toward individuals who like pets and are over 21 years of age. A beer ad could be weighted toward individuals who are male, over age 21, and who like sports. Therefore, if a 30 year old male user who likes the San Diego Chargers comes into proximity of the detector proximity field 127, the advertising manager 130 can compute the ad correlation for the beer ad as (10+10+10=>30) and the pet ad as (0+10=>10). So, in this example the beer ad will prevail and will likely get displayed to the user. Additionally if there is ad space remaining for other ads, then those other ads may show up in weighted order preference. Further, the same weight for ad selection applies for all users within proximity or users likely to be in proximity (based on previous location history). Alternatively, a random selection or random weighting may occur to improve ad selection diversity.

In block 506, the advertising manager 130 retrieves the advertisement with the highest correlation to the PPC table.

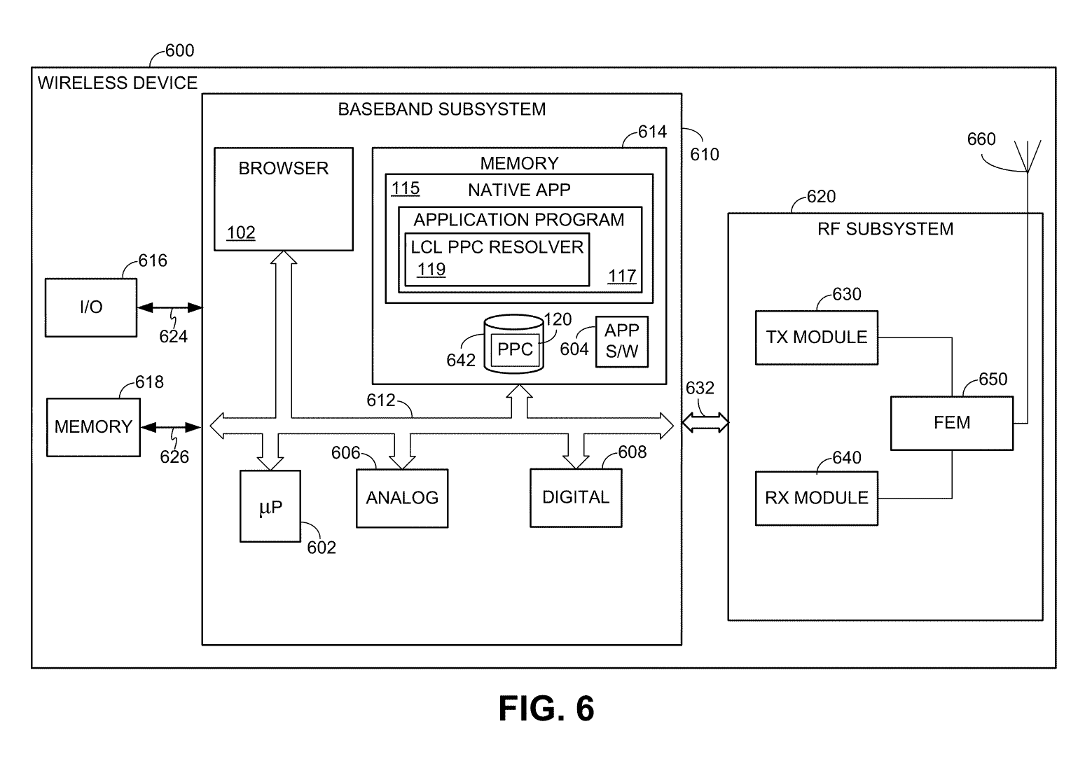

FIG. 6 is a block diagram illustrating an example of a wireless device 600 in which aspects of the method and system for targeting advertisements to multiple users can be implemented. In an embodiment, the wireless device 600 can be a “Bluetooth” wireless communication device, a portable cellular telephone, a WiFi enabled communication device, or can be any other communication device. Embodiments of the method and system for targeting advertisements to multiple users can be implemented in any communication device. The wireless device 600 illustrated in FIG. 6 is intended to be a simplified example of a cellular telephone and to illustrate one of many possible applications in which the method and system for targeting advertisements to multiple users can be implemented. One having ordinary skill in the art will understand the operation of a portable cellular telephone, and, as such, implementation details are omitted. In an embodiment, the wireless device 600 includes a baseband subsystem 610 and an RF subsystem 620 connected together over a system bus 632. The system bus 632 can comprise physical and logical connections that couple the above-described elements together and enable their interoperability. In an embodiment, the RF subsystem 620 can be a wireless transceiver. Although details are not shown for clarity, the RF subsystem 620 generally includes a transmit module 630 having modulation, upconversion and amplification circuitry for preparing a baseband information signal for transmission, includes a receive module 640 having amplification, filtering and downconversion circuitry for receiving and downconverting an RF signal to a baseband information signal to recover data, and includes a front end module (FEM) 650 that includes diplexer circuitry, duplexer circuitry, or any other circuitry that can separate a transmit signal from a receive signal, as known to those skilled in the art. An antenna 660 is connected to the FEM 650.

The baseband subsystem 610 generally includes a processor 602, which can be a general purpose or special purpose microprocessor, memory 614, application software 604, analog circuit elements 606, and digital circuit elements 608, coupled over a system bus 612. The system bus 612 can comprise the physical and logical connections to couple the above-described elements together and enable their interoperability.

An input/output (I/O) element 616 is connected to the baseband subsystem 610 over connection 624 and a memory element 618 is coupled to the baseband subsystem 610 over connection 626. The I/O element 616 can include, for example, a microphone, a keypad, a speaker, a pointing device, user interface control elements, and any other devices or system that allow a user to provide input commands and receive outputs from the wireless device 600.

The memory 618 can be any type of volatile or non-volatile memory, and in an embodiment, can include flash memory. The memory 618 can be permanently installed in the wireless device 600, or can be a removable memory element, such as a removable memory card.

The processor 602 can be any processor that executes the application software 604 to control the operation and functionality of the wireless device 600. The memory 614 can be volatile or non-volatile memory, and in an embodiment, can be non-volatile memory that stores the application software 604.

The analog circuitry 606 and the digital circuitry 608 include the signal processing, signal conversion, and logic that convert an input signal provided by the I/O element 616 to an information signal that is to be transmitted. Similarly, the analog circuitry 606 and the digital circuitry 608 include the signal processing elements used to generate an information signal that contains recovered information from a received signal. The digital circuitry 608 can include, for example, a digital signal processor (DSP), a field programmable gate array (FPGA), or any other processing device. Because the baseband subsystem 610 includes both analog and digital elements, it can be referred to as a mixed signal device (MSD).

The baseband subsystem 610 also comprises an instance of the web browser 102. The memory 614 comprises a database 642 and an instance of the native application 115, which includes an instance of the context application program 117, which includes an instance of the local PCC resolver 119. In an example embodiment, the database 642 stores contextual data related to the wireless device 600 obtained from the context application program 117. In an embodiment of the system for targeting advertisements to multiple users, the database 642 stores a PPC table 120 related to the wireless device 600.

### Example

Two riders (Lewis and Clare) are in a car headed to Las Vegas. They are about an hour outside of Las Vegas when they encounter the detector proximity field 127. The advertising manager 130 is notified of the presence of the two users and is provided with PPC information about the users.

Profiles:
Lewis—likes sports and beer, is male, eats fast food, likes to stay home, lives with Clare.
Clare—likes sports, is female, eats healthy, likes Las Vegas, lives with Lewis.

Preferences:
Lewis—Favorite Beer: Lite, Favorite Food: Hot Wings, Favorite Team: Chargers, Likes: fast American cars.
Clare—Favorite Food: Sushi, Favorite Brands: X, Favorite Team: Broncos, Likes: Shopping and slot machines.

Context:
Lewis—Lives in San Diego, on the way to Las Vegas, charger game tomorrow. Last food stop 3 hours ago.
Clare—Lives in San Diego, on the way to Las Vegas, Bronco game tomorrow. Didn't make reservations, needs a room!

The advertising manager 130 receives and processes the PPC information. Based on PPC information the advertising manager 130 determines the following, 50% of the area on the advertising medium 104 will showcase a hotel ad for a 2-day room stay package that comes with free admission to the hotel's Denver Broncos-San Diego Chargers football game watching party with tail gate. In this example, 10% of the area on the advertising medium 104 will say “Hotel PPC, has the best hot wings in Las Vegas,” 30% of the area on the advertising medium 104 will feature an ad for a particular fast automobile, and 10% of the area on the advertising medium 104 will feature the latest purse from brand X. The content of the advertising medium 104 is likely to change based on time (different ad information) and other factors.

In view of the disclosure above, one of ordinary skill in programming is able to write computer code or identify appropriate hardware and/or circuits to implement the disclosed invention without difficulty based on the flow charts and associated description in this specification, for example. Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the FIGS. which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and Blu-Ray disc where disks usually reproduce data magnetically, while discs reproduce data optically with lasers. Combinations of the above should also be included within the scope of computer-readable media.

Although selected aspects have been illustrated and described in detail, it will be understood that various substitutions and alterations may be made therein without departing from the spirit and scope of the present invention, as defined by the following claims.

What is claimed is:

1. A method for targeting an advertisement, comprising:
receiving contextual data related to a plurality of users;
aggregating the contextual data related to the plurality of users;
sensing when the plurality of users approaches an advertising medium;
tailoring one or more advertisements to the plurality of users based on the contextual data; and
providing the one or more targeted advertisements to the plurality of users through the advertising medium.

2. The method of claim 1, wherein one advertisement is targeted to a plurality of users.

3. The method of claim 1, wherein a plurality of advertisements are targeted to a plurality of users.

4. The method of claim 1, wherein the advertising medium comprises a plurality of display portions, each display portion configured to display an advertisement related to one of the plurality of users.

5. The method of claim 1, wherein the contextual data comprises user profile information, user preference information and user context information.

6. The method of claim 1, wherein the contextual data is assigned a weighted value and the weighted value is used to determine which of a plurality of targeted advertisements are provided to the plurality of users.

7. The method of claim 6, wherein a targeted advertisement is compared against the weighted value to determine which of a plurality of targeted advertisements are provided to the plurality of users.

8. A system for targeting an advertisement, comprising:
contextual data related to a plurality of users;
an organizer software module for aggregating the contextual data related to the plurality of users;
an interaction detector for sensing when the plurality of users approaches an advertising medium;
a selection software module for tailoring one or more advertisements to the plurality of users based on the contextual data; and
an advertising medium for providing the one or more targeted advertisements to the plurality of users.

9. The system of claim 8, wherein one advertisement is targeted to a plurality of users.

10. The system of claim 8, wherein a plurality of advertisements are targeted to a plurality of users.

11. The system of claim 8, wherein the advertising medium comprises a plurality of display portions, each display portion configured to display an advertisement related to one of the plurality of users.

12. The system of claim 8, wherein the contextual data comprises user profile information, user preference information and user context information.

13. The system of claim 9, wherein the contextual data is assigned a weighted value and the weighted value is used to determine which of a plurality of targeted advertisements are provided to the plurality of users.

14. The system of claim 13, wherein a targeted advertisement is compared against the weighted value to determine which of a plurality of targeted advertisements are provided to the plurality of users.

15. A system, comprising:
means for receiving contextual data related to a plurality of users;
means for aggregating the contextual data related to the plurality of users;
means for sensing when the plurality of users approaches an advertising medium;
means for tailoring one or more advertisements to the plurality of users based on the contextual data; and
means for providing the one or more targeted advertisements to the plurality of users through the advertising medium.

16. The system of claim 15, wherein one advertisement is targeted to a plurality of users.

17. The system of claim 15, wherein a plurality of advertisements are targeted to a plurality of users.

18. The system of claim 15, wherein the advertising medium comprises a plurality of display portions, each display portion comprising means for displaying an advertisement related to one of the plurality of users.

19. The system of claim 15, wherein the contextual data comprises user profile information, user preference information and user context information.

20. The system of claim 15, wherein the contextual data is assigned a weighted value and the weighted value is used to determine which of a plurality of targeted advertisements are provided to the plurality of users.

21. The system of claim 20, wherein a targeted advertisement is compared against the weighted value and the system further comprises means for determining which of a plurality of targeted advertisements are provided to the plurality of users.
